(19) United States
(12) Patent Application Publication
(10) Pub. No.: US 2022/0091041 A1
(43) Pub. Date: Mar. 24, 2022

(54) NANOWIRE ARRAY FOR USE WITH RAMAN SPECTROSCOPY

(71) Applicant: University of Louisville Research Foundation, Inc., Louisville, KY (US)

(72) Inventor: XIAOAN FU, Louisville, KY (US)

(21) Appl. No.: 17/439,839

(22) PCT Filed: Mar. 16, 2020
(86) PCT No.: PCT/US20/22990

§ 371 Date: Sep. 16, 2021

Related U.S. Application Data
(60) Provisional application No. 62/820,956, filed on Mar. 20, 2019.

(51) Int. Cl. G01N 21/65

(52) U.S. Cl. CPC G01N 21/658; B82Y 15/00

(57) ABSTRACT

The present invention is directed to microfabricated silicon nanowire arrays, and more particularly, to microfabricated silicon nanowire arrays for use with surface enhanced Raman spectroscopy (SERS) and methods of making and using the same in the detection of trace chemicals analytes in liquid and gaseous samples.

This application claims the benefit of U.S. provisional patent application Ser. No. 62/820,956, filed 20 Mar. 2019, for NANOWIRE ARRAY FOR RAMAN SPECTROSCOPY AND METHOD OF USING THE SAME, incorporated herein by reference.

### FIELD OF THE INVENTION

The present invention is directed to microfabricated silicon nanowire arrays, and more particularly, to microfabricated silicon nanowire arrays for use with surface enhanced Raman spectroscopy and methods of making and using the same in the detection of trace chemical analytes in liquid and gaseous samples.

### BACKGROUND

Surface enhanced Raman spectroscope (SERS) is defined as the signal enhancement in Raman spectroscopy due to Raman scattering and the excitement of the localized surface plasmon resonance. The enhancement stems from an electromagnetic enhancement mechanism and the chemical etchant mechanism. SERS is very promising for fast detection of drug abuse and point-of-care detection of diseases.

As an increasing number of states legalize the recreational or medical use of marijuana, it will become necessary to create a method for portable and rapid detection of tetrahydrocannabinol (THC), the principal psychoactive component of cannabis. In addition, as Traditional drug tests using blood or urine are slow and not practical for on-site identification of individuals impaired due to use of marijuana. Liquid chromatography-tandem mass spectrometry (LC-MC) and field asymmetric ion mobility spectrometry (FAIM) have found success in identifying THC in exhaled breath. However, LC-MC and FAIM are not suitable for on-site testing, due to the size and expense of mass spectrometers. A need exists for a portable, rapid, and cost-effective means for evaluating an individuals' consumption of marijuana. SERS for drug detection has become a topic of interest due to the potential for on-site detection for law enforcement and point-of-care application. By combining microfluidics with a portable Raman spectrometer, researchers have been able to identify trace amounts of methamphetamine in liquid samples. However, there is no simple device for SERS to detect THC or methamphetamine in exhaled breath.

Structures such as micropillars, nanopillars and nanowires have been utilized as substrates for SERS in conjunction with gold or silver nanoparticles. Arrays of nanowires or nanopillars can provide the necessary surface roughness for SERS. However, traditional methods of nanoparticle deposition onto nanostructures can produce signal variability due to uneven distribution of nanoparticles, resulting in non-optimal limits of detection.

### SUMMARY

A microfabricated silicon nanowire array with silver nanoparticle coating for surface enhanced Raman spectroscopy (SERS) may be useful in the detection of trace chemicals analytes in gaseous and liquid samples, such as, for example, detection of THC in exhaled breath samples. Fabrication of the silicon nanowire array device for SERS is accomplished using wet etching without use of a mask. The nanowire array contacts a sample, such as an exhaled breath sample, and is subjected to SERS. The disclosed silicon nanowire array coated with sputtered silver nanoparticles has been shown to achieve a limit of detection of 3.1 pg of THC. The linear relationship between SERS signal and the amount of THC indicate that the device and method are suitable for quantification of the concentration dilute chemical species in exhaled breath samples.

It will be appreciated that the various systems and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1A depicts a schematic cross-sectional view of a substrate.

FIG. 1B depicts a schematic cross-sectional view of the substrate of FIG. 1A with a nanowire array formed therein.

FIG. 1C depicts a schematic cross-sectional view of the nanowire array of FIG. 1B with an Ag thin film formed thereon.

FIG. 1D depicts the nanowire array of FIG. 1C after thermal annealing.

FIG. 2 depicts a SEM micrograph of silicon nanowires created by etching in 5 M HF and 0.02 M AgNO₃ solution.

FIG. 3 depicts a SEM micrograph of silicon nanowires created by etching in 8.15 M HF and 0.02 M AgNO₃ solution.

FIG. 4 is a chart depicting SERS spectra of THC added on silver nanoparticles coated silicon nanowires.

FIG. 5 is a chart depicting the relationship between the amount of THC (x-axis, in pictograms) and intensity of SERS (peak at 1375 cm−1).

FIG. 6 is a chart depicting the SERS spectrum of 1.0*10⁷ pg of THC on silver thin film coated bare silicon plate.

### DETAILED DESCRIPTION OF THE PREFERRED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

Specific quantities (spatial dimensions, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated. Unless stated otherwise, explicit approximate quantities (e.g., “about” or “substantially”) refer to a range of ±5% of the recited quantities (e.g., “about 1” refers to 0.95 to 1.05; “about 20” refers to 19 to 21; “substantially perpendicular” refers to an angle of 85° to 95°.

Embodiments of the present invention relate to a silicon nanowire array and methods of making and using the same. The nanowire arrays of the present invention include a silicon substrate, a plurality of nanowires extending substantially perpendicularly from the substrate, and a reactive chemical disposed on the tips of the nanowires.

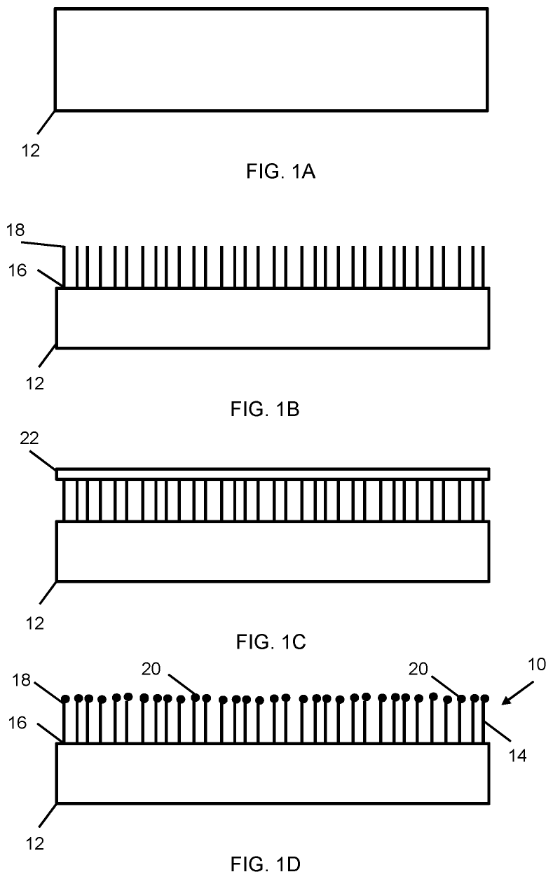

FIGS. 1A-1D schematically depict a process for forming a nanowire array for Raman spectroscopy, specifically, SERS. The nanowire array 10 includes a substrate 12 and a plurality of nanowires 14 extending substantially perpendicular to the substrate 12, such that each nanowire 14 includes a base 16 from which it extends from the substrate 12 and a tip 18 opposite the base 16. A plurality of Ag nanoparticles 20 are disposed on at least the tips 18 of the nanowires 14.

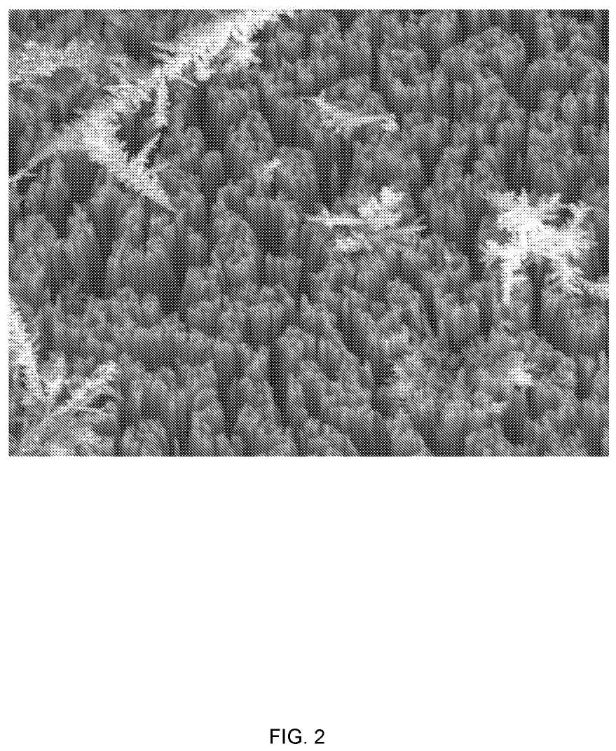

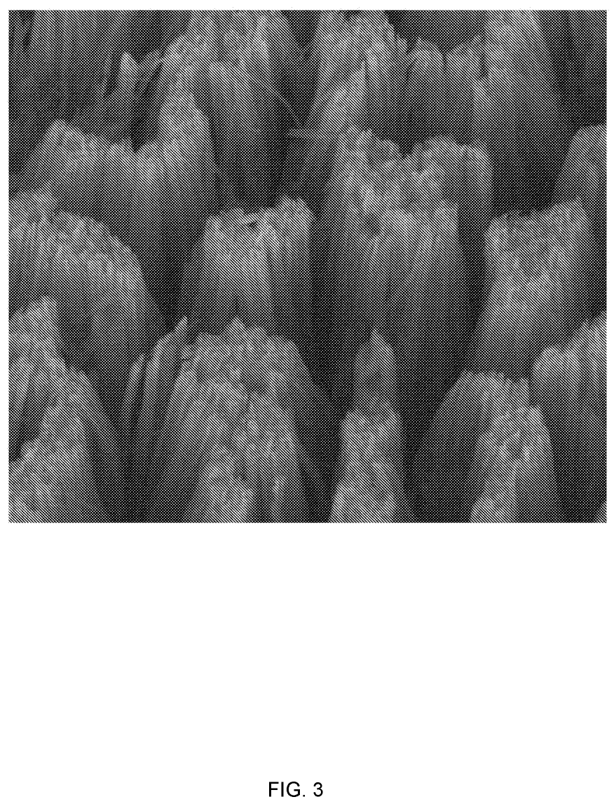

The substrate 12 is preferably composed of silicon, and in some embodiments is a silicon chip. In one embodiment, the nanowire array 10 is formed by providing a 1 cm×1 cm×500 micrometer silicon chip as substrate 12 (FIG. 1A), although any sized chip may be used. The substrate 12 is then etched using a HF/AgNO₃ solution to form nanowires 14 in the substrate 12 via a redox reaction (FIG. 1B). In some embodiments, the HF/AgNO₃ solution was maintained between 25° C. and 40° C., between 30° C. and 35° C., at 30° C., at 35° C., or above room temperature during the etching process. The duration and temperature of the etching process may vary based on the desired nanowire height, as higher temperatures and longer durations increase etching of the substrate 12, resulting in greater height for the resulting nanowires 14. FIG. 2 depicts a silicon nanowire array created by wet etching in 5 M HF and 0.02 M AgNO₃ solution. Silver nanoparticles with a feathered appearance were formed on the top of the nanowires, the nanoparticles being a residual from the HF/AgNO₃ solution. These randomly spaced and shaped silver nanoparticles do not produce strong and consistent SERS signals for detection of chemical species. As such, after etching, the nanowire array 10 is next placed into a nitric acid bath to remove residual silver from the HF/AgNO₃ from the nanowire array 10. Then, the nanowire array 10 is cleaned with deionized water. FIG. 3 depicts a silicon nanowire array created by wet etching in 8.15 M HF and 0.02 M AgNO₃ solution after removal of residual silver nanoparticles via nitric acid and water washing. As shown by comparing FIGS. 2 and 3, etching with the 5 M HF solution provides a greater density of nanowires than etching with the 8.15 M HF solution, such that modification of the HF concentration allows for modification of the density of the resulting nanowire array.

The nanowires 14 arrays on the chips were then coated with an Ag thin film 22 by sputtering Ag using a Lesker PVD 75 sputterer (FIG. 10). In some embodiments the thickness of the coating is about 5 nm to about 10 nm. The chips were then heated by a rapid thermal annealing process as necessary to crack the Ag thin film to form Ag nanoparticles clustered at the tips of the nanowires (FIG. 1D). In some embodiments, the chips were heated by applying a heat of about 800° C. for about one minute. In other embodiments, heat was applied for less than one minute. Without being bound by theory, forming Ag nanoparticles by applying an Ag thin film coating followed by thermal cracking results in a more uniform distribution of Ag nanoparticles than traditional techniques for application of Ag nanoparticles, resulting in less variability in SERS signals and consequent improvement in detection sensitivity.

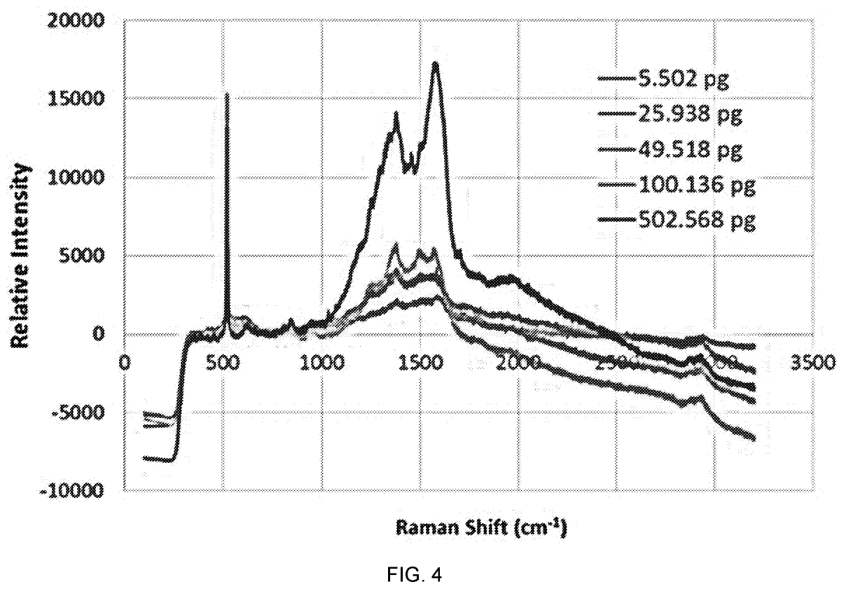

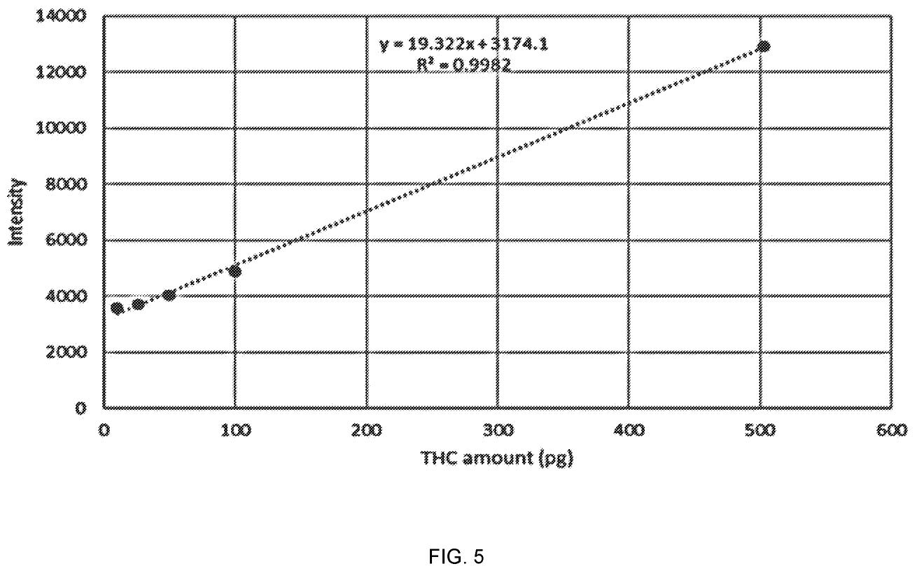

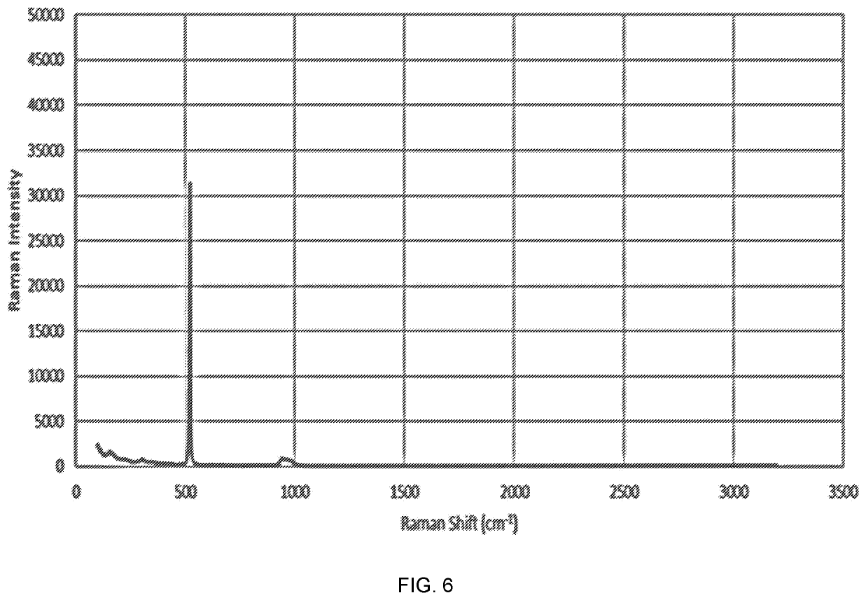

The Ag nanoparticle-coated nanowire array disclosed herein may be used in the detection of dilute chemical species by SERS. A liquid or gaseous sample may be contacted to the disclosed nanowire array and chemical species from the sample retained on the nanowire array. Raman spectroscopy was used to characterize SERS of the silicon nanowire array with Ag thin film coating for detection of the chemical species. For testing purposes, a known amount of THC in methanol was gradually added on the top of the silicon nanowire array of the chip for SERS measurements. FIG. 4 shows Raman spectra of THC quantities ranging from 5.5 pg to 502.6 pg added on silver nanoparticle coated silicon nanowire array shown in FIG. 2. The characteristic peak of THC is at 1375 cm⁻¹. FIG. 5 shows a linear relationship between the intensity at 1375 cm⁻¹ and the amounts of THC on the chip. For comparison, FIG. 6 shows Raman spectra for a silicon plate coated with silver thin film (i.e., a silicon substrate without formed nanowires) to which 10 micrograms of THC were added. A similar heating step did not result in cracking of the thin film, as the bare silicon plate did not have texture (e.g., the tips of the nanowires) to create stress points in the thin film to facilitate cracking. This Ag thin film coated silicon substrate was not effective in retaining THC for detection via SERS, as only the characteristic peak of silicon is shown in FIG. 6.

Incorporation of Ag nanoparticles by applying a Ag thin film then thermally cracking the film produces a chip-based detection system with improved sensitivity and limit of detection, and thus allows for use of SERS in detection of trace chemicals in amounts as low as single digits of picograms, and possibly lower. While the provided data shows use of this nanowire array in the detection of THC, it should be understood that other chemicals may be detected as well, including but not limited to tetrahydrocannabinolic acid (THCA) and methamphetamine. In addition, while the provided data discloses nanowire arrays with Ag nanoparticles, it should be understood that silver-thiol complexes are also contemplated within the scope of this invention.

In certain embodiments, the chip-based detection system disclosed herein is coupled to or incorporated within a microfluidic device configured to direct liquid or gaseous samples to the Ag nanoparticle-coated nanowire array.

Various aspects of different embodiments of the present disclosure are expressed in paragraphs X1, X2, and X3 as follows:

X1: One embodiment of the present disclosure includes a device for collecting at least one chemical analyte from a gaseous or liquid sample, the device comprising: a substrate; a plurality of nanowires extending substantially perpendicularly from the substrate, wherein each nanowire includes a base attached to the substrate and a tip opposite the base; and an Ag nanoparticle coating disposed at least on the tips of the plurality of nanowires; wherein the Ag nanoparticle coating is capable of forming a conjugate with the at least one chemical analyte to thereby retain the at least one chemical analyte with the device.

X2: Another embodiment of the present disclosure includes a process for fabricating a nanowire array, comprising: providing a silicon substrate; forming a nanowire array on the silicon substrate; applying an Ag thin film coating on the nanowire array; and cracking the Ag thin film coating to form a plurality of Ag nanoparticles on the nanowire array.

X3: A further embodiment of the present disclosure includes A method for detection and quantification of a chemical analyte, the method comprising: providing a detection device including a substrate, a plurality of nanowires extending substantially perpendicularly from the substrate, wherein each nanowire includes a base attached to the substrate and a tip opposite the base, and an Ag nanoparticle coating disposed at least on the tips of the plurality of nanowires, wherein the Ag nanoparticle coating is capable of forming a conjugate with the at least one chemical analyte to thereby retain the chemical analyte with the device; contacting the detection device with the chemical analyte to retain at least a portion of the chemical analyte with the detection device; analyzing the chemical analyte retained with the detection device to detect and quantify the chemical analyte.

Yet other embodiments include the features described in any of the previous paragraphs X1, X2, or X3 as combined with one or more of the following aspects:

Wherein the Ag nanoparticle coating is formed by cracking an Ag film disposed at least on the tips of the plurality of nanowires.

Wherein the Ag nanoparticle coating is formed by thermally cracking an Ag film disposed on at least the tips of the plurality of nanowires.

Wherein the Ag nanoparticle coating is formed by rapid thermal annealing to crack an Ag film disposed on at lease the tips of the plurality of nanowires.

Wherein the Ag film has a thickness of about 5 nm to about 10 nm.

Wherein the Ag film has a thickness of 5 nm to 10 nm.

Wherein the forming is enacted by chemical etching using a solution, the solution including HF and AgNO₃.

Wherein the solution is maintained at a temperature above room temperature during the etching.

Wherein the solution is maintained between 25° C. and 40° C. during the etching.

Wherein the solution is maintained between 30° C. and 35° C. during the etching

Wherein the forming is enacted by etching the silicon support structure via a redox reaction.

Wherein the applying is enacted by sputtering an Ag thin film coating on the nanowire array.

Wherein the cracking is enacted by applying heat to the Ag thin film coating.

Wherein the cracking is enacted by subjecting the Ag thin film coating to a temperature of about 800° C.

Wherein the cracking is enacted by subjecting the Ag thin film coating to an elevated temperature for not more than about one minute.

Wherein the cracking is enacted by subjecting the Ag thin film coating to an elevated temperature for not more than one minute.

Wherein the Ag thin film coating has a thickness of about 5 nm to about 10 nm.

Wherein the process further comprises washing the array using nitric acid after said forming and prior to said applying.

Wherein the analyzing includes using a Raman spectrometer.

Wherein the analyzing includes using surface effect Raman spectroscopy (SERS).

Wherein the chemical analyte is tetrahydrocannabinol, tetrahydrocannabinolic acid, or methamphetamine.

Wherein the chemical analyte is in a liquid or gaseous sample.

Wherein the chemical analyte is a liquid or gaseous sample including tetrahydrocannabinol, tetrahydrocannabinolic acid, or methamphetamine.

Wherein the chemical analyte is in an exhaled breath sample.

Wherein the Ag nanoparticle coating is formed by cracking an Ag film disposed at least on the tips of the plurality of nanowires.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1) A device for collecting at least one chemical analyte from a gaseous or liquid sample, the device comprising:
a substrate;
a plurality of nanowires extending substantially perpendicularly from the substrate, wherein each nanowire includes a base attached to the substrate and a tip opposite the base; and
an Ag nanoparticle coating disposed at least on the tips of the plurality of nanowires;
wherein the Ag nanoparticle coating is capable of forming a conjugate with the at least one chemical analyte to thereby retain the at least one chemical analyte with the device.

2) The device of claim 1, wherein the Ag nanoparticle coating is formed by cracking an Ag film disposed at least on the tips of the plurality of nanowires.

3) The device of claim 2, wherein the Ag film has a thickness of about 5 nm to about 10 nm.

4) The device of claim 1, wherein the Ag nanoparticle coating is formed by thermally cracking an Ag film disposed on at least the tips of the plurality of nanowires.

5) A process for fabricating a nanowire array, comprising:
providing a silicon substrate;
forming a nanowire array on the silicon substrate;
applying an Ag thin film coating on the nanowire array; and
cracking the Ag thin film coating to form a plurality of Ag nanoparticles on the nanowire array.

6) The process of claim 5, wherein the forming is enacted by chemical etching using a solution, the solution including HF and AgNO₃.

7) The process of claim 6, wherein the solution is maintained at a temperature above room temperature during the etching.

8) The process of claim 6, wherein the solution is maintained between 25° C. and 40° C. during the etching.

9) The process of claim 5, wherein the forming is enacted by etching the silicon support structure via a redox reaction.

10) The process of claim 5, wherein the applying is enacted by sputtering an Ag thin film coating on the nanowire array.

11) The process of claim 5, wherein the cracking is enacted by applying heat to the Ag thin film coating.

12) The process of claim 5, wherein the cracking is enacted by subjecting the Ag thin film coating to a temperature of about 800° C.

13) The process of claim 5, wherein the cracking is enacted by subjecting the Ag thin film coating to an elevated temperature for not more than about one minute.

14) The process of claim 5, wherein the Ag thin film coating has a thickness of about 5 nm to about 10 nm.

15) The process of claim 5, further comprising washing the array using nitric acid after said forming and prior to said applying.

16) A method for detection and quantification of a chemical analyte, the method comprising:
providing a detection device including
a substrate,
a plurality of nanowires extending substantially perpendicularly from the substrate, wherein each nanowire includes a base attached to the substrate and a tip opposite the base, and
an Ag nanoparticle coating disposed at least on the tips of the plurality of nanowires,
wherein the Ag nanoparticle coating is capable of forming a conjugate with the at least one chemical analyte to thereby retain the chemical analyte with the device;
contacting the detection device with the chemical analyte to retain at least a portion of the chemical analyte with the detection device;
analyzing the chemical analyte retained with the detection device to detect and quantify the chemical analyte.

17) The method of claim 16, wherein the analyzing includes using a Raman spectrometer.

18) The method of claim 16, wherein the analyzing includes using surface effect Raman spectroscopy (SERS).

19) The method of claim 16, wherein the chemical analyte is tetrahydrocannabinol, tetrahydrocannabinolic acid, or methamphetamine.

20) The method of claim 16, wherein the chemical analyte is in a liquid or gaseous sample.

21) The method of claim 20, wherein the chemical analyte is in an exhaled breath sample.

22) The method of claim 16, wherein the Ag nanoparticle coating is formed by cracking an Ag film disposed at least on the tips of the plurality of nanowires.
